(19) United States
(12) Patent Application Publication
(10) Pub. No.: US 2007/0101654 A1
(43) Pub. Date: May 10, 2007

(54) Spring Wiper for Curl Spring Balances

(75) Inventor: Jeffrey Charles Robertson, Rochester, NY (US)

Correspondence Address: BROWN & MICHAELS, PC;400 M & T BANK BUILDING, 118 NORTH TIOGA ST, ITHACA, NY, 14850, US

(73) Assignee: Caldwell Manufacturing Company, Rochester, NY (US)

(21) Appl. No.: 11/552,699

(22) Filed: Oct. 25, 2006

Related U.S. Application Data
(60) Provisional application No. 60/729,892, filed on Oct. 25, 2005.

(51) Int. Cl. E05F 1/00

(52) U.S. Cl. 49/445

(57) ABSTRACT

A spring wiper for curl springs contained within curl spring mounts, holders or shoes operatively engaged with window sashes that are located in window shoe channels. The spring wiper is deployed on the curl spring holder or mount and contains a wiper blade that is transverse to the curl spring, spanning its width, in order to wipe or scrape debris clinging to and/or accumulated on the surface of the curl spring exposed to airborne particulate matter when the curl spring is extended prior to its being retracted into the curl spring mount or holder, thereby keeping such debris from entering the inside of the curl spring mount or holder and interfering with the continued fluid operation of the sash.

### BACKGROUND OF THE INVENTION

1. Field of the Invention

The invention pertains to the field of window balances. More particularly, the invention pertains to a wiper for the curl springs of these balances.

2. Description of Related Art

Constant force curl springs have been used in window balance systems where they have the advantage of applying a constant lifting force to counterbalance the constant weight of a window sash. The constant force of these springs is derived from the curling tendency of an uncurled length of a spring steel strip that has been formed to curl up. When the strips are uncurled and extended, each increment of the extended strip is biased to recurl itself and thus exerts a constant force against spring extension.

However, until fairly recently, curl springs were not popular in window counterbalance systems, because each of their known arrangements suffered from at least one competitive drawback. For example, sash mounted arrangements of curl springs did not allow the sash to tilt; jamb mounted arrangements took up window space that manufacturers were unwilling to commit to balance systems; and tilt sash arrangements were inefficient and sometimes short-lived or inadequate in performance. The result was that only a few of the many different proposed arrangements of curl spring balance systems were being marketed, and these had only a small market share.

However, new discoveries in the realm of curl spring and shoe arrangement were patented in U.S. Pat. Nos. 5,353,548 and 5,463,793. The arrangements claimed in these patents accommodate a tilt sash and employ curl springs in a much more efficient manner. Curled up convolutions of the springs are carried by or contained within sash shoes, also referred to as curl spring mounts, that run in sash channels alongside a sash moving in sash runs. A connection between the shoes and the sash allows the sash to tilt, and the springs apply a constant counterbalance lifting force to the shoes, which transmit this lift to the sash. Free end regions of uncurled lengths of the springs are mounted within the shoe channels so that the springs curl up into the shoes as the shoes move upward in the shoe channels and uncurl from the shoes into the shoe channels as the shoes move downward in the shoe channels. Alternative designs involve the use of two shoes, one fixed to the window jamb channel at a desired location and a traveling shoe which contains one end of the curl spring and is affixed to the stile of the window sash so that as the sash is moved the traveling shoe uncoils the curl spring from the fixed shoe. The traveling shoe is also referred to as a locking shoe.

One specific problem that arises when such window designs are used in new construction is that when the curl spring is extended as the sash is moved from its resting position along the window jambs, there is a great potential for dust and dirt to attach to the extended spring. Then when the sash is returned to its resting or closed position and the spring is re-coiled within the shoes, the dust and dirt will accumulate within the coiled spring, causing it to become clogged. This can either partially or completely inhibit the movement of the sash. This problem is particularly acute with new construction because the windows are usually installed early in the construction process, before insulation and drywall are installed. Since drywall installation requires repeated sanding, the fine particulate plaster dust freely drifts around the room attaching itself not only to horizontal surfaces, but vertical ones, as well, such as the exposed curl springs of open windows, leading to the problems discussed above.

### SUMMARY OF THE INVENTION

The invention is a spring wiper for curl springs used in window sash systems. The curl spring is contained in a coiled position within a carrier, mount, cassette, shoe or holder. The curl spring uncoils from its coiled position within the holder as the sash is moved either up or down to open the window. In a first embodiment of the invention, the spring wiper is deployed on top of and interlocks with features of the curl spring holder. In this first embodiment, the curl spring holder, or shoe, is pinned to the bottom of each of the two sash stiles by a sash pin while the open end of the spring is secured in the shoe channel at the end of the uppermost limit of travel of the bottom rail of the sash.

In a second embodiment of the invention, a curl spring mount is permanently secured at the top of the shoe channel of the window frame jamb. In this second embodiment, the end of the curl spring is secured to a locking shoe which is pinned to a stile of the sash by a sash pin which allows it to travel up and down the shoe channel as the sash is raised and lowered. In this embodiment, the spring slides along the surface of the shoe channel as the sash is raised and lowered. The wiper blade is an integral part of the curl spring mount and wipes the side of the spring facing the window opening as the sash is returned to its closed window position and the curl spring returns to its coiled position inside the curl spring mount.

The spring wiper has a wiper blade that is deployed on the curl spring holder or mount so that it presses against the side of the uncoiled portion of the curl spring that is exposed to airborne particulate contamination. The wiper blade has an edge that is preferably transverse to the curl spring, spanning its width, and wipes/scrapes debris clinging to and/or accumulated on the curl spring when it is extended prior to its being re-coiled within the curl spring mount or holder. In this way, it is able to keep such debris from entering the coiled portion of the curl spring and interfering with the continued fluid operation of the sash.

Either the first or the second embodiment may include a curl spring mount or holder that can accommodate more than one curl spring, usually two and sometimes three. The additional spring(s) would travel in and out of the curl spring mount or holder through an opening on the opposite side from the opening for the first curl spring. A separate wiper blade wipes clean the additional spring(s) before their re-entry into the curl spring mount or holder.

### BRIEF DESCRIPTION OF THE DRAWING

FIG. 1 is a partially schematic side view of a window with sash shoe showing the balance system cooperating with a tilted sash.

FIG. 2 is a side view of the curl spring holder of FIG. 1.

FIG. 3 is a cross-sectional view of the curl spring holder of FIG. 2.

FIG. 4 provides a perspective view of the spring wiper for curl spring holders of the first embodiment of the invention.

FIG. 5 provides a schematic side view of the first embodiment of the spring wiper in functional position on a curl spring holder.

FIG. 6 provides a perspective view of the second embodiment of the invention with the curl spring extended between a fixed curl spring mount and a locking shoe.

FIG. 7 provides a perspective view of the second embodiment of FIG. 6 with the curl spring re-coiled within the fixed curl spring mount.

FIG. 8 provides a perspective view of the second embodiment showing a variation of the design of the spring wiper with the curl spring extended.

FIG. 9 provides a perspective view of the variation of the second embodiment of FIG. 8 with the curl spring re-coiled within the fixed curl spring mount.

### DETAILED DESCRIPTION OF THE INVENTION

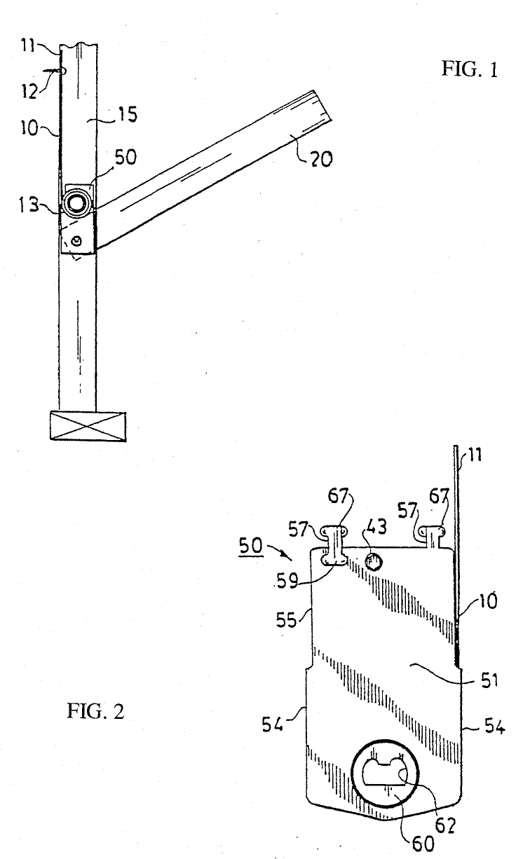

U.S. Pat. Nos. 5,353,548 and 5,463,793 provide numerous details related to the construction, operation and advantages of the curl spring holder 50 of the first embodiment of this invention and are hereby incorporated by reference. FIG. 1 schematically shows a generally preferred arrangement for employing curl springs 10 and curl spring holders 50 with a counterbalancing sash 20. Free end regions 11 of springs 10 are fixed in positions within shoe channels 15, as schematically indicated by fastener 12. Curled up convolutions 13 of springs 10 are contained within curl spring holder 50, which move up and down in shoe channels 15 as sash 20 moves up and down in vertical sash runs within the frame of the window (not shown). Curl spring holders 50 are interconnected with sash 20, preferably by means of pivot bars or pins, which allow sash 20 to tilt, as shown in FIG. 1. Curl spring holders 50 preferably lock in shoe channels 15 when sash 20 tilts, but it is also possible to allow curl spring holders 50 to rise in channels 15 from the upward bias of springs 10 when tilting of sash 20 removes some of the sash weight from curl spring holders 50.

The curl spring counterbalance arrangement schematically shown in FIG. 1 achieves the general advantages mentioned above. In this design, potential friction caused by sliding an uncurled length of a curl spring against a shoe channel surface as a sash moves is substantially eliminated. Spring 10 rests flat and motionless against shoe channel wall 15 as spring 10 recurls into coiled convolutions 13 when curl spring holders 50 and sash 20 are moved upward and uncurls from curl spring holders 50 into shoe channel 15 when curl spring holders 50 and sash 20 are moved downward.

Containment of curled up spring convolutions 13 in curl spring holders 50 accommodates the balance springs to the vertical travel desired for sash 20. Free end region 11 of spring 10 can be secured in shoe channel 15 above the uppermost limit of travel of curl spring holders 50 with sash 20. This level can be above the upper rail of sash 20, because a tilt latch, which is commonly arranged at the upper rail of a tilt sash (not shown), can move up and down over the mounting of free end region 11 without interference.

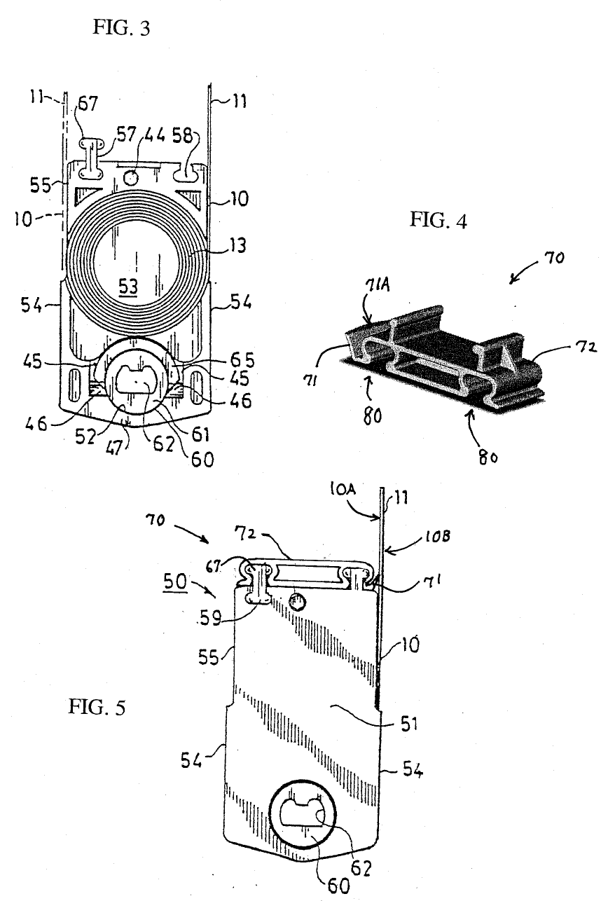

As illustrated in FIGS. 2 through 3, curl spring holder 50 can advantageously be formed of two identical parts or halves 51 so that any one of the parts 51 can join with any other part 51 to form a complete body for curl spring holder 50. Each body part 51 is formed to provide half of a containment region 53 for receiving the curled up convolutions 13 of spring 10. Each body part 51 also provides half of an opening 52 for a pin or pivot bar receiver 60. Opposite lower sides 54 of body parts 51 are parallel and separated by a suitable distance for a smooth sliding fit in shoe channel 15, and upper sides 55 of body parts 51 are separated by a smaller distance to allow a length of spring 10 to pass from containment region 53 in between one of the curl spring mount side walls 55 and a wall of shoe channel 15. Assembling curl spring holder 50 from a pair of identical body parts 51 also gives curl spring holder 50 identical front and rear faces so that the curl spring holder 50 can be installed with either face confronting sash 20. Conventional moldable materials, such as plastics, resins, nylon and the like may be used to make the various components of the curl spring holder.

A projection 57 and a recess 58 are formed at the top of each body part 51 so that the downward facing portion 59 of each projection 57 can be slid into recess 58 of a confronting body part as shown in FIG. 3. When body parts 51 are then pressed together, the downward facing portions of projections 59 interlocking with slots 58 and thus hold body parts 51 in the assembled relation of FIGS. 2 and 5. Before this is done, curled spring convolutions 13 are placed in containment region 53 so that spring 10 extends out of an opening 56, and receiver 60 is positioned in opening 52 between the body parts. This makes the assembly of curl spring holder 50 simple and inexpensive because it is accomplished by positioning a spring 10 and a receiver 60 in one body part and then simply pressing another body part into a confronting position that is held securely by the interference fit between projections 59 and slots 58.

Receiver 60 has a preferably cylindrical body 61 with a through opening 62 that receives a pin or pivot bar connected to sash 20. Receiver 60 thus participates in a connection between curl spring holder 50 and sash 20, and many variations of such a connection are possible. A platform or other support can extend from curl spring holder 50 to sash 20, for example. Window jambs normally include a slot between the sash run and the shoe channel 15 allowing a connector such as pin 63 to extend between curl spring holder 50 and sash 20.

Receiver 60 preferably includes a cam 65 formed as an annular sector extending part way around cylindrical body 61. Cam 65 fits within a recess 45 in each of the body parts 51, and inclined cam follower surfaces 46 connect recess 45 with a confronting face surface 47 of each body part 51. When cam surface 65 is positioned in recess 45, in the neutral or sash vertical position for receiver 60, confronting surfaces 47 of body parts 51 are closed or engaged. When sash 20 tilts, receiver 60 is turned or pivoted within curl spring holder 50, which makes cam 65 ride up one of the inclined surfaces 46 onto face surface 47. This spreads body parts 51 apart by the thickness of cam 65. It also allows cam 65 to pivot in either direction to accomplish the cammed separation of body parts 51. This thickens or widens curl spring holder 50 by increasing the separation between its front and back surfaces so that curl spring mount 50 locks in shoe channel 15 when sash 20 tilts. The amount that the curl spring mount widens is determined by the thickness of cam 65, which can be varied to meet different shoe locking requirements. The top of curl spring holder 50, which is held together by projections 59 in recesses 58, remains tightly assembled, and shoe body parts 51 flex to allow the cammed separation of their lower regions when the shoe locks. This provides not only a simple locking arrangement for a sash curl spring holder, but it also provides more locking force from the torque applied by sash tilting than is achieved with other locking mechanisms that operate by spreading apart portions of the mount. The spreading of curl spring holder 50 occurs in a direction parallel with sash 20, which extends across the narrower of the generally rectangular dimensions of shoe channel 15; and this may account for the improved locking force provided by cam 65 disposed between face surfaces 47.

Curl spring holder 50 can also be provided with adjustable friction, although there is less need for friction adjustment in curl spring balance systems because of the normally constant force of the curl springs. If the spring lift is a little excessive, though, or if the upper sash has a tendency to drop from an uppermost position, the frictional fit of curl spring holder 50 in shoe channel 15 can be increased. This is preferably done by means of an opening 44 formed eccentrically into an upper region of body parts 51 so that openings 44 in a pair of assembled body parts do not register with each other. Then, a screw 43 can be threaded into an opening 44 in one of the body parts 51, and its leading end will engage a confronting surface of the mating body part. Further turning of the screw will urge the upper regions of body parts 51 apart, to thicken curl spring holder 50 enough to increase its frictional resistance to movement in channel 15.

When exposed to excessive dust, such as during new construction, including extremely fine particulates resulting from, for example, the repeated sanding of drywall in proximity to the window, this dust accumulates on the uncoiled length of curl spring 10 when sash 20 is moved from its resting or closed position (which draws curl spring 10 out of curl spring holder 50 and extends it along shoe channel 15). In this position, an inward side 10A of the spring 10, the side facing the window opening, is particularly exposed to dust accumulation, while a wall facing side 10B rests flat against shoe channel wall 15 and is largely protected from such accumulation. Thus, it is extremely important that the inward side 10A be cleaned prior to or while moving the sash 20 upward, as upward movement otherwise results in the recoiling of spring 10 within curl spring holder 50, trapping construction dust in the curled up spring convolutions 13 within the curl spring holder 50. Although not shown in the drawings, at least one more curl spring may be employed. The other spring(s) would travel in and out of the other side of the curl spring holder 50

In order to alleviate this problem, the first embodiment of the invention consists of a mounting apparatus 70 having a spring wiper 71 for curl spring holders 50 that is deployed on top of and engages interlocking features of curl spring holder 50. The wiper blade 71 extends from a mounting apparatus (base 72) that can be affixed in spaced relationship adjacent spring 10. In this embodiment, base 72 is mounted onto curl spring holder 50 via interlocking mating elements (projections 57 having heads 67) on the top of the curl spring holder 50. Projections 57 and heads 67 snap onto or securely slide into interface elements (recesses 80) of the base 72. Spring wiper 71 is inclined in relation to, and presses against, the inward surface 10A of the curl spring 10 adjacent the curl spring holder 50. Its edge 71A is somewhat arcuate and transverse to the curl spring 10 and spans the width of the curl spring. Thus, as the curl spring holder 50 moves with the sash (and curl spring 10 recoils in its interior containment region 53), the edge 71A of cleaning member 71 acts as a scraper, scraping dust and other detritus off of and away from the inward surface 10A of curl spring 10 before it is recoiled into interior containment region 53.

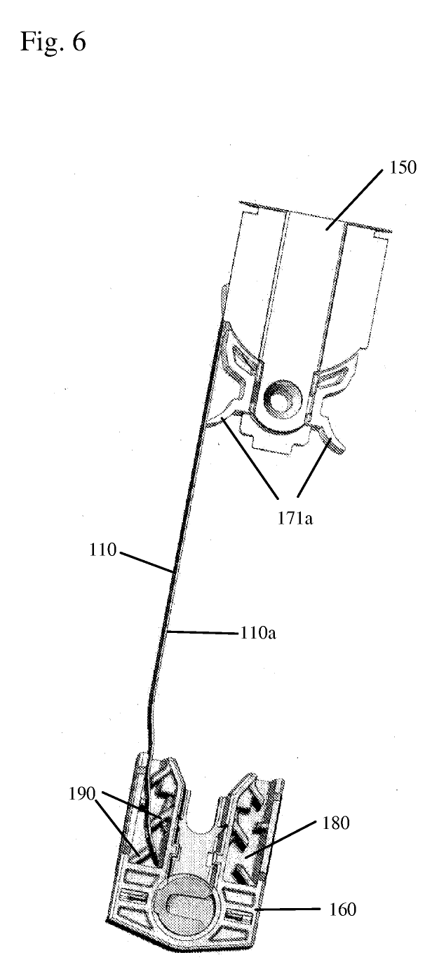

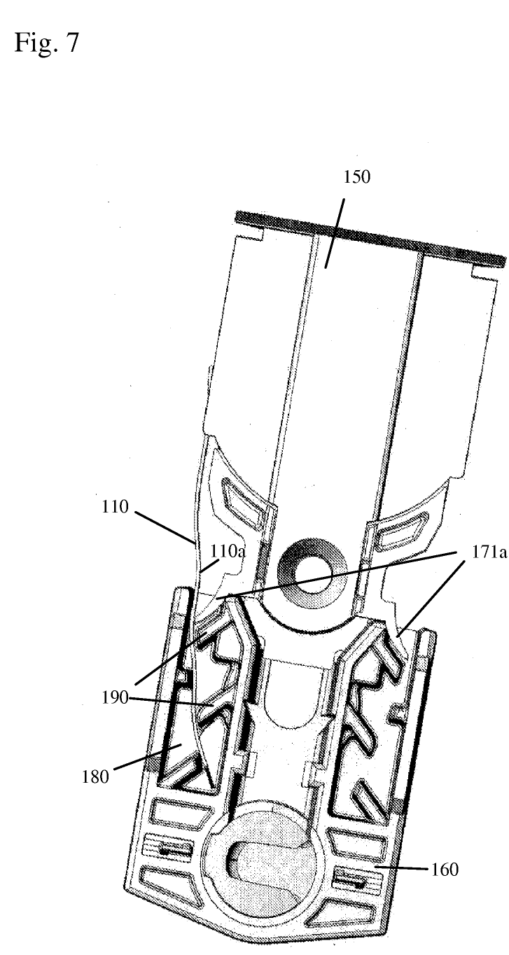

A second embodiment of the present invention is illustrated in FIGS. 6-9. One variation is shown in FIGS. 6 and 7. It consists of a curl spring mount 150 that contains an internal containment region for accommodating at least one curled up spring, as illustrated in the curl spring holder 50 in FIG. 3. Instead of the curl spring mount 150 riding up and down a shoe channel in the window jamb, as described above with respect to the first embodiment, a locking shoe 160 is secured to the vertical stile of a sash (not shown) and travels in the shoe channel as the sash is moved up and down. The locking shoe 160 performs a function similar to that of curl spring mount 50 described in the first embodiment during the tilting operation of the sash. The curl spring mount 150 is secured at a fixed position within the shoe channel of the window jamb. One end of the curl spring 110 is securely affixed in a spring lock channel 180 of locking shoe 160 by a plurality of locking tabs 190. At least one outwardly projecting wiper blade 171a is an integral part of the body of the curl spring mount 150. The outwardly projecting wiper blade 171a is positioned to be in forceful contact with the exposed inward surface 110a of curl spring 110. As the window is closed, the sash is returned to its closed position. The locking shoe 160 returns to meet the curl spring mount 150 and curl spring 110 returns to its coiled position within curl spring mount 150. As the curl spring 110 retracts into the curl spring mount 150, surface 110a is wiped of dust and other detritus by outwardly projecting wiper blade 171a. Variations of this embodiment provide that at least one more spring may be incorporated within the curl spring mount 150. The additional spring(s), at most two, would travel in and out of the curl spring mount 150 through an opening on the opposite side of the curl spring mount 150 from the opening for curl spring 110. A separate integral wiper blade, also designated 171a, wipes clean the additional spring(s) before re-entry into the curl spring mount 150.

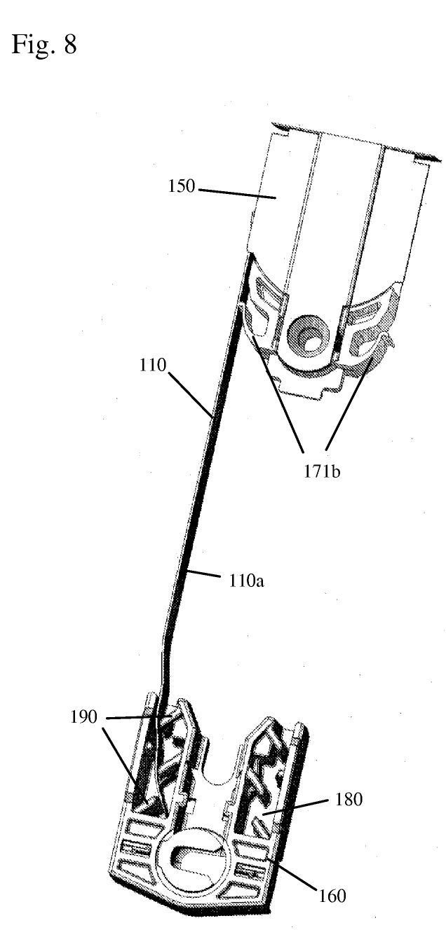

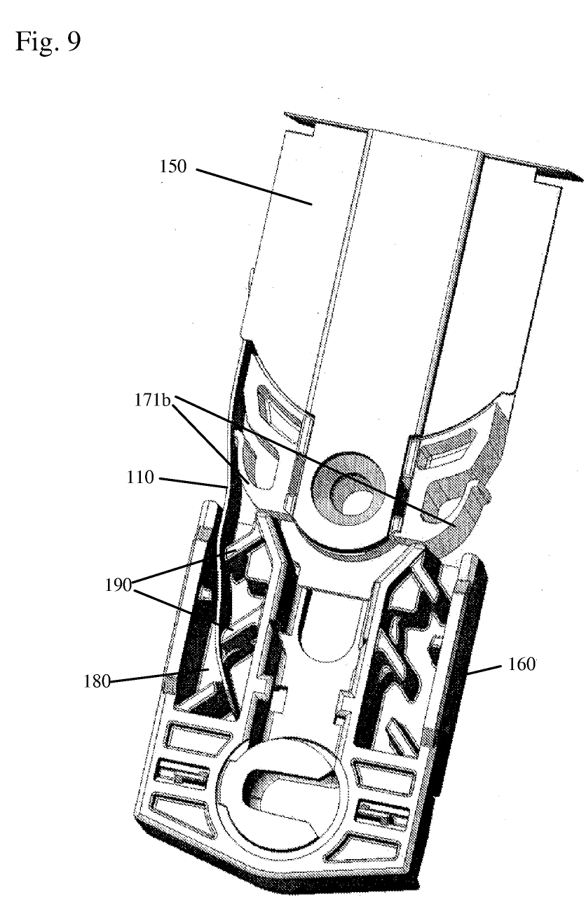

FIGS. 8 and 9 show another variation of the second embodiment of the invention, the only difference being that the wiper blade 171b is projects inwardly. Either an outwardly projecting wiper blade 171a or an inwardly projecting wiper blade 171b is suitable for use with this second embodiment. The choice is simply the result of design optimization for each particular application. The wiper blade is made of a material that provides it with a degree of flexibility to exert a sufficient force on the inward surface 110a of the curl spring 110 to enable it to remove unwanted dust and detritus therefrom. Suitable materials are well known and may include various molded plastics or elastomeric materials.

It should be readily apparent that the separate wiper 70 described within the curl spring balance system of the first embodiment may be used with the curl spring mount and locking shoe system, 150 and 160, respectively, described within the second embodiment. Similarly, the integral wiper described in the second embodiment may be utilized with the curl spring holder 50 of the first embodiment. The common element is the wiper blade that is used to wipe the inward surface of the curl spring upon retraction into its curled position within the curl spring mount or holder within which it is housed.

However, and notwithstanding the foregoing description of a preferred embodiment, it is clear that numerous variations can be made without exceeding the scope of the inventive concept. Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A spring wiper for a curl spring contained within a coil in a holder or mount, the holder or mount operatively engaged with a window sash, comprising a wiper blade to wipe clean a side of the curl spring that is exposed to airborne particulate contaminants as the curl spring retracts into the holder or mount.

2. A spring wiper for a curl spring contained within a curl spring holder, the curl spring holder containing at least one curl spring, the at least one curl spring being coiled within the curl spring holder when unextended, and uncoiled when extended, a mounting apparatus for the spring wiper deployed on a top portion of the curl spring holder comprising at least one wiper blade in wiping contact with a surface of the uncoiled portion of the at least one curl spring as the uncoiled curl spring retracts into the curl spring holder.

3. The spring wiper of claim 2, wherein the mounting apparatus is separate from the curl spring holder and is provided with interlocking elements that are joined to mating elements of the curl spring holder forming an interlocking fit therewith.

4. The spring wiper of claim 2, wherein the wiper blade is transverse to the curl spring.

5. The spring wiper of claim 2 wherein the curl spring holder is secured to a stile of a window sash and travels up and down with the window sash within a shoe channel of a window.

6. The spring wiper of claim 2 wherein the surface of the uncoiled portion of the at least one curl spring is exposed airborne dust and detritus.

7. A spring wiper for a curl spring contained within a curl spring mount, the curl spring mount being securely mounted at the top of a shoe channel of a window, one end of the curl spring being secured to a locking shoe, the locking shoe secured to a stile of a window sash in order to travel up and down the shoe channel with the window sash comprising at least one wiper blade in wiping contact with a surface of an uncoiled portion of at least one curl spring, wherein the spring wiper is an integral part of the curl spring mount.

9. The spring wiper of claim 8 wherein the wiper blade is transverse to the surface of the curl spring.

10. The spring wiper of claim 8 wherein the surface of the uncoiled portion of the at least one curl spring is exposed to airborne dust and detritus.

11. The spring wiper of claim 8 wherein the at least one wiper blade projects outwardly from the curl spring mount.

12. The spring wiper of claim 8 wherein the at least one wiper blade projects inwardly toward the curl spring mount.

13. A method for wiping dust and detritus from an exposed surface of at least one uncoiled curl spring as the at least one curl spring retracts into a curl spring holder, the curl spring holder secured to a stile of a window sash and contains at least one wiper blade that is in forceful contact with the exposed surface of the at least one curl spring comprising retracting the at least one curl spring into the curl spring holder by moving the window sash from an open window position to a closed window position.

14. A method for wiping dust and detritus from an exposed surface of at least one uncoiled curl spring as the at least one curl spring retracts into a curl spring mount, the curl spring mount secured to a channel in a window frame, the channel enabling a window sash to move between an open window position and a closed window position comprising retracting the at least one curl spring into the curl spring mount by moving the window sash from the open window position to the closed window position.
